(19) United States
(12) Patent Application Publication
(10) Pub. No.: US 2023/0193951 A1
(43) Pub. Date: Jun. 22, 2023

(54) PLAIN BEARING WITH IMPROVED WEAR RESISTANCE

(71) Applicant: AKTIEBOLAGET SKF, GOTEBORG (SE)

(72) Inventors: Joanna Stefania DZWONCZYK, Ijsselstein (NL); Grant James DENNIS, Pontypridd (GB); Michael Brett COLTON, Bristol (GB)

(21) Appl. No.: 17/991,125

(22) Filed: Nov. 21, 2022

(30) Foreign Application Priority Data
Dec. 20, 2021 (EP) 21215943.8

(51) Int. Cl. F16C 33/12; F16C 17/10

(52) U.S. Cl. CPC F16C 33/121; F16C 17/10; F16C 33/10

(57) ABSTRACT

A plain bearing includes a metal outer ring having an inner surface and a metal inner ring having an outer surface configured to cooperate with the inner surface of the outer ring to permit relative movement of the inner and outer rings. At least the outer surface of the inner ring is provided with a plasma electrolytic oxidation coating and/or at least the inner surface of the outer ring is provided with a plasma electrolytic oxidation coating.

### CROSS-REFERENCE

This application claims priority to European patent application no. 21215943.8 filed on Dec. 20, 2021, the contents of which are fully incorporated herein by reference.

### TECHNOLOGICAL FIELD

The present disclosure is directed to plain bearings and more specifically, to plain bearings having improved wear resistance that are particularly suitable for aerospace applications.

### BACKGROUND

Typically, in self-lubricating plain bearings, hard materials such as steel, or hard coatings such as ceramics, are used coupled with a self-lubricating material. The combination results in an optimized wear and friction resistance at the interface between the inner ring and the outer ring of the plain bearing.

The self-lubricating material is usually provided as a liner and is considered as a consumable material, whereas the opposing counter-surface is optimized to have no or very low wear.

In order to comply with weight reduction requirements of the aerospace industry, heavy materials of plain bearings such as steel are being replaced by light alloys. Light alloys, however, have poor tribological properties, especially when used as a countersurface that rubs against a composite self-lubricating liner. For example, under very low loads, aluminum alloy exhibits abrasive wear after very few oscillating cycles.

It is known to apply hard coatings by surface treatment method such as Physical Vapor Deposition (PVD) or High Velocity Oxy Fuel (HVOF) to enhance the lifetime of plain bearings made of steel, but also light alloys such as titanium.

Nevertheless, coatings obtained by HVOF or PVD techniques cannot be applied to certain light alloys as a substrate, such as aluminum, since the high process temperatures of these methods would lead to overaging the material and thus adversely affect its mechanical properties.

Because PVD and HVOF techniques are not suitable for aluminum light alloys, it is possible to form an electrochemically produced layer of aluminum oxide on the surface of aluminum alloy by a hard anodizing method. The resulting coating improves the wear resistance of the aluminum alloy. The downside of this solution is that the wear resistance of the coated aluminum alloy still remains low as compared with coated steels.

Consequently, the present invention intends to overcome these disadvantages by providing a plain bearing having an improved wear resistance that can be obtained from light alloys such as aluminum having limited wear resistance properties.

### SUMMARY

One aspect of the disclosure is to provide a plain bearing having an outer ring and an inner ring each made of a metal material and comprising respectively an inner surface and an outer surface intended to cooperate with each other for the relative movement of the outer and inner rings.

In a first embodiment, at least the outer surface of the inner ring is provided with a plasma electrolytic oxidation coating.

In a second embodiment, at least the inner surface of the outer ring is provided with the plasma electrolytic oxidation coating.

In a third embodiment, at least the outer surface of the inner ring and at least the inner surface of the outer ring are provided with the plasma electrolytic oxidation coating.

According to an embodiment, the metal material may be an aluminum alloy. Advantageously, the major alloying element of the aluminum alloy may be copper, zinc, or a combination of magnesium and silicon.

Preferably, the plain bearing further includes a self-lubrification liner between the inner surface of the outer ring and the outer surface of the inner ring. In this case, the plain bearing is a self-lubricating plain bearing. More preferably, the self-lubricating liner may comprise a phenolic resin matrix filled with glass fibers.

According to an embodiment, the outer surface of the inner ring may be made of aluminum alloy having the outer surface coated with a plasma electrolytic oxidation coating and the outer ring may be made of an aluminum alloy material having the inner surface uncoated.

Advantageously, the plain bearing may be a spherical plain bearing. In this case, the inner surface of the outer ring is concave and the outer surface of the inner ring is convex. Advantageously, the plain bearing may be used in an aerospace application.

The disclosure is also directed to a method of manufacturing a plain bearing that includes:
providing an outer ring and an inner ring comprising respectively an inner surface and an outer surface intended to cooperate with each other for the relative movement of the outer and inner rings;
forming a coating by a plasma electrolytic oxidation process on the inner surface of the outer ring and/or on the outer surface of the inner ring; and
assembling the outer ring and the inner ring.

### BRIEF DESCRIPTION OF THE DRAWING

Other advantages and features of the disclosure will appear from the detailed description of embodiment of the invention, which are non-limiting example, illustrated on the appended drawing of which:

FIG. 1 is a perspective view of a spherical plain bearing according to an embodiment of the disclosure.

### DETAILED DESCRIPTION

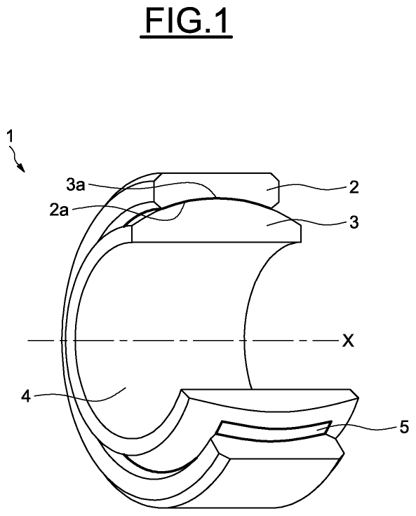

Referring to FIG. 1, a spherical plain bearing 1 having a main axis of rotation X comprises an outer ring 2 concentrically positioned with respect to an inner ring 3. The exemplified plain bearing 1 is a lightweight plain bearing for aerospace applications.

The outer ring 2 has a concave bore or inner surface 2a of spherical shape, and the inner ring 3 has a convex outer surface 3a of spherical shape. The inner ring 3 also comprises a cylindrical bore 4.

The inner and outer surfaces 2a, 3a are facing each other and are of corresponding shapes to permit a relative motion between them the outer ring 2 and the inner ring 3.

In the illustrated example, the plain bearing 1 is a self-lubricating plain bearing. The plain bearing 1 comprises a self-lubricating liner 5 radially interposed between the inner surface 2a of the outer ring 2 and the outer surface 3a of the inner ring 3. The self-lubricating liner 5 reduces friction and permits a reduced wear rate during the service life of the plain bearing 1.

The liner 5 may be in form of a sheet and attached to one of the inner surface 2a of the outer ring 2 or the outer surface 3a of the inner ring 3. In the illustrated example, the liner 5 is fixed to the inner surface 2a of the outer ring 2 and has a sliding contact surface facing the outer surface 3a of the inner ring 3. The outer ring 3 radially comes into contact against the inner ring 2 by interposition of the liner 5.

The liner 5 may comprise a composite material, for example a phenolic resin matrix filled with glass fibers.

In the illustrated example, both the inner ring 3 and the outer ring 2 are made of a metal material.

The outer surface 3a of the inner ring 3 is coated with a plasma electrolytic oxidation coating, hereinafter referred to as PEO coating. In another embodiment, the inner surface 2a of the outer ring 2 can comprise the plasma electrolytic oxidation coating. In another embodiment, both the outer surface 3a of the inner ring 3 and the inner surface 2a of the outer ring 2 can comprise the plasma electrolytic oxidation coating.

In order to facilitate the manufacturing process, the PEO coating can be alternatively formed on the entire surface of the inner ring 3.

The plasma electrolytic oxidation, also known as microarc oxidation, is an electrochemical surface treatment process suitable for light metal alloys that allows the formation of a protective layer of oxide at the surface of a substrate.

The process of forming a PEO coating comprises the application at room temperature of an electrical potential to the substrate, which is the outer surface 3a of the inner ring 3 in the illustrated example, with the substrate placed in an aqueous electrolyte. A pulsed voltage is passed through a bath of the electrolyte and applied to the substrate. The resulting plasma discharge leads to the formation of a hard and dense ceramic layer. For example, the PEO coating is a Keronite® coating.

In the illustrated embodiment, the metal material comprises an aluminum alloy. Aluminum alloys are light alloys particularly suitable for aerospace applications. The major alloying element of the aluminum alloy is preferably copper, or zinc, or a combination of magnesium and silicon. In particular, the aluminum-based alloys from 2/6/7xxx series may be selected. The aluminum alloy can be, for example, AA7075 alloy, preferably AA7075 T73511.

In another embodiment, the inner ring 3 and/or the outer ring 2 can be made from different light alloys such as, for example, titanium alloy or magnesium alloy.

The illustrated outer ring 2 is also made of aluminum alloy, for example of aluminum alloy is AA7075 alloy, preferably AA7075 T73511.

According to an embodiment, the inner ring 3 made of aluminum alloy having an outer surface 3a of the inner ring 3 coated with a PEO coating can be combined with an uncoated inner surface 2a of the outer ring 2.

The disclosure is also directed to a method of manufacturing a plain bearing 1 that includes providing an outer ring 2 and an inner ring 3 having, respectively an inner surface 2a and an outer surface 3b intended to cooperate with each other for the relative movement of the outer and inner rings 2, 3. The outer and inner rings 2, 3 provided are made of metal material.

A coating is formed by plasma electrolytic oxidation process on the outer surface 3b of the inner ring 3. According to an embodiment, the method can comprise, as an alternative, forming a PEO coating on the inner surface 2a of the outer ring 2 or on both the inner surface 2a of the outer ring 2 and the outer surface 3b of the inner ring 3. The outer ring 2 and the inner ring 3 are then assembled.

The use of a PEO coating improves the wear resistance of the inner ring 3 when it is subjected to friction against the hard sliding contact surface of the liner 5. The liner 5 may include, for example, hard and abrasive fillers particles such as glass fibers.

Therefore, the resulting self-lubricating plain bearing 1 exhibits a better mechanical resistance, and improved wear properties of the self-lubricating liner 5 and, consequently, an extended service life.

Forming a PEO coating makes it possible to manufacture a lightweight plain bearing based on light alloy suitable for aerospace applications with a service life at least equal to a plain bearing based on steel. The PEO coating forms an optimized hard counter-surface which exhibits little to no wear and maintains a low wear rate of the self-lubricating liner 5 material. The wear resistance of the material combination of the PEO coating and the self-lubricating liner 5 is improved. This allows for a long-life plain bearing using light alloy, such as aluminum alloy, suitable for aerospace applications.

The use of PEO coating significantly improves the performance of the interaction between the PEO coating and the self-lubricating liner 5 compared to a coating obtained by hard anodizing. In addition, the PEO coating can additionally improve the corrosion resistance and the mechanical performance of the outer ring 2 and/or inner ring 3 where deposited.

The manufacturing method for obtaining the PEO coating is simple and is compatible with the thermal properties of light alloys, such as aluminum alloy, which are sensitive to high temperature processes, and has minimal impact on the mechanical performance of these light alloys.

In the illustrated example, the plain bearing is a self-lubricating plain bearing provided with the liner. Alternatively, the plain bearing may not be provided with the liner. In this case, the outer ring 2 comes into direct radial contact against the inner ring 3.

In the illustrated example, the plain bearing is a radial spherical plain bearing. Alternatively, the plain bearing may be an angular contact spherical plain bearing or a thrust spherical plain bearing. In another embodiment, the plain bearing may be a cylindrical plain bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved plain bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A plain bearing comprising:
a metal outer ring having an inner surface; and
a metal inner ring having an outer surface configured to cooperate with the inner surface of the outer ring to permit relative movement of the inner and outer rings,
wherein at least the outer surface of the inner ring is provided with a plasma electrolytic oxidation coating and/or at least the inner surface of the outer ring is provided with a plasma electrolytic oxidation coating.

2. The plain bearing according to claim 1, wherein the metal outer ring comprises an aluminum alloy and/or the metal inner ring comprises an aluminum alloy.

3. The plain bearing according to claim 2, wherein a major alloying element of the aluminum alloy is copper, zinc, or a combination of magnesium and silicon.

4. The plain bearing according to claim 3, including a self-lubrification liner between the inner surface of the outer ring and the outer surface of the inner ring.

5. The plain bearing according to claim 4, wherein the self-lubricating liner comprises a phenolic resin matrix filled with glass fibers.

6. The plain bearing according to claim 2, wherein the outer surface of the inner ring is coated with the plasma electrolytic oxidation coating and the inner surface of the outer ring is not coated with the plasma electrolytic oxidation coating.

7. The plain bearing according to claim 1, wherein the inner surface of the outer ring is concave and the outer surface of the inner ring is convex.

8. The plain bearing according to claim 1, including a self-lubrification liner between the inner surface of the outer ring and the outer surface of the inner ring.

9. The plain bearing according to claim 8, wherein the self-lubricating liner comprises a phenolic resin matrix filled with glass fibers.

10. A method of manufacturing a plain bearing comprising:
providing an outer ring and an inner ring configured to cooperate with each other for relative movement;
forming a coating by a plasma electrolytic oxidation process on an inner surface of the outer ring and/or on an outer surface of the inner ring; and
assembling the outer ring and the inner ring to form the plain bearing.

11. The method according to claim 10,
wherein assembling the outer ring and the inner ring includes providing a self-lubricating liner between the inner ring and the outer ring, the self-lubricating liner comprising a phenolic resin matrix filled with glass fibers.
